(19) United States
(12) Patent Application Publication
(10) Pub. No.: US 2002/0036222 A1
(43) Pub. Date: Mar. 28, 2002

(54) Automobile CD player holder

(76) Inventor: Michael M. Gerardi, Beverly Hills, CA (US)

Correspondence Address: Michael M. Gerardi, Suite 202, 412 N. Oakhurst Drive, Beverly Hills, CA, 90210, US

(21) Appl. No.: 09/898,516

(22) Filed: Jul. 2, 2001

Related U.S. Application Data
(63) Continuation-in-part of application No. 09/372,324, filed on Aug. 11, 1999, now Pat. No. 6,253,982.

(51) Int. Cl. B60R 7/04

(52) U.S. Cl. 224/544; 224/929

(57) ABSTRACT

A holder for releasably securing a personal CD player within a motor vehicle equipped with a center console includes a base, an element for securing the base to the center console, an element for securing the article to the base, and an element for securing a CD jewel case.

This is a continuation-in-part of U.S. patent application Ser. No. 09/372,324 , filed Aug. 11, 1999, the disclosure of which is incorporated in its entirety herein by reference.

### FIELD OF THE INVENTION

The present invention relates to devices for securing portable articles such as compact disc (CD) players, cellular telephones, small televisions and the like. More particularly, the present invention relates to devices for securing a personal CD player and a CD jewel case, in particular the jewel case of a CD that is to be played using the personal CD player.

### BACKGROUND OF THE INVENTION

Many modern consumer electronic devices, such as CD players, can be utilized in motor vehicles. Frequently, the motor vehicle is equipped with a cigarette lighter, and power is supplied to the electronic device by a special adapter which plugs into the cigarette lighter. Audio devices such as CD players often are also provided with adapters to facilitate playing of CD's through a tape deck that is part of the vehicle's audio system. However, motor vehicles, in particular automobiles, frequently are not equipped with receptacles or mounting surfaces which can accommodate the electronic devices. As a result, the electronic devices cannot be secured within the motor vehicles, resulting in inconvenience for the vehicle operator as well as a potential safety hazard.

A need exists for a device that secures a portable electronic device, such as a CD player, within a motor vehicle but within easy reach of the vehicle operator.

Also in the particular case of a personal CD player, once a CD is inserted into the player, the CD's jewel case should be appropriately stowed in order to prevent loss or breakage of the jewel case. A need thus exists for a device that also provides stowage for a CD jewel case.

### SUMMARY OF THE PREFERRED EMBODIMENTS

In accordance with one aspect of the present invention, there is provided a holder for releasably securing a personal CD player within a motor vehicle which includes a base, means for securing the base within the motor vehicle, means for securing the CD player to the base, and means for securing a CD jewel case.

In accordance with another aspect of the present invention, there is provided a method for releasably securing a personal CD player and CD jewel case within a motor vehicle employing the inventive holder.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a left perspective view of a first preferred embodiment of the inventive holder for use with center consoles having cup holders, shown releasably securing a personal CD player.

FIGS. 2a-c are top plan, front elevation and bottom plan views of the embodiment of FIG. 1.

FIG. 3 is a top plan view of an alternative embodiment having an enclosed receptacle for the article to be secured.

FIGS. 4a-b are exploded side and front end views of an alternative embodiment of the inventive holder which includes additional mechanical element for securing an article (as shown, a personal CD player) to the holder.

FIG. 5 is a side view showing the position of the holder of FIGS. 1 and 2a-c with respect to a center console of a vehicle that includes a cup holder.

FIG. 6 is a side view of an alternative embodiment of the inventive holder which includes additional elements for securing the base thereof to the center console.

FIG. 7 is a side view of another embodiment of the inventive holder and its position relative to an inclined center console.

FIGS. 8a-c are bottom plan (with respect to the center projecting element), side and top plan views of the holder shown in FIG. 7, showing the angled projecting element.

FIG. 9 is a side view of an alternative holder which is secured to a center console by suction means.

FIGS. 10a-c are top plan, side elevational and front elevational views of another embodiment of the inventive holder that includes prongs for securing any excessive length of a power cord used to supply power to the article secured by the holder.

FIG. 11 is a side sectional view of an alternative embodiment of the inventive holder that includes a resilient layer for dampening vibrations transmitted from the center console to the article secured by the holder.

FIGS. 12a-b are top plan and front elevation views of an alternative embodiment of the inventive holder that includes a receptacle for a CD jewel case defined in the base of the holder.

FIGS. 13a-b are top plan and front elevation views of another alternative embodiment of the inventive holder including an external CD jewel case holder.

FIGS. 14a-b are top plan and front elevation views of a further alternative embodiment of the inventive holder including an external CD jewel case holder.

FIGS. 15a-c are top plan and two side elevation views of another alternative embodiment of the inventive holder including an external CD jewel case holder with a flexible base element, with FIG. 15c showing the holder in a flexed position.

FIG. 16a-c are side, top plan and front elevation views of an alternative embodiment of the inventive holder including a CD jewel case holder that pivotally engages with the base of the holder.

FIGS. 17a-c are top plan, side and rear elevational views of a further embodiment of the inventive holder including receptacles for external power and audio plugs.

Like numerals refer to like parts throughout the several views of the drawings.

### DETAILED DESCRIPTION OF THE PREFERRED EMBODIMENTS

As used herein, a “center console” denotes any element that extends between the driver and front passenger seats in a vehicle such as an automobile, truck, van, etc. Center consoles typically include one or more of the following: storage compartments, cup holders, stick shifts and instrument clusters. Center consoles can be affixed to, or project from, a vehicle dashboard, or can project from and/or rotate away from a point between the driver and front passenger seats.

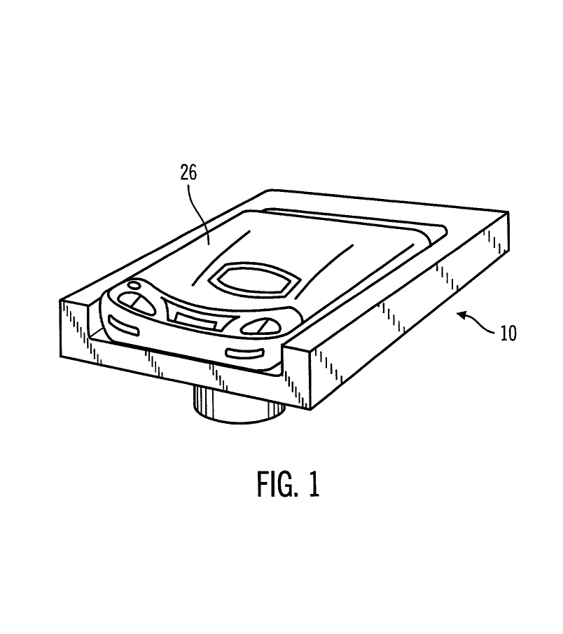

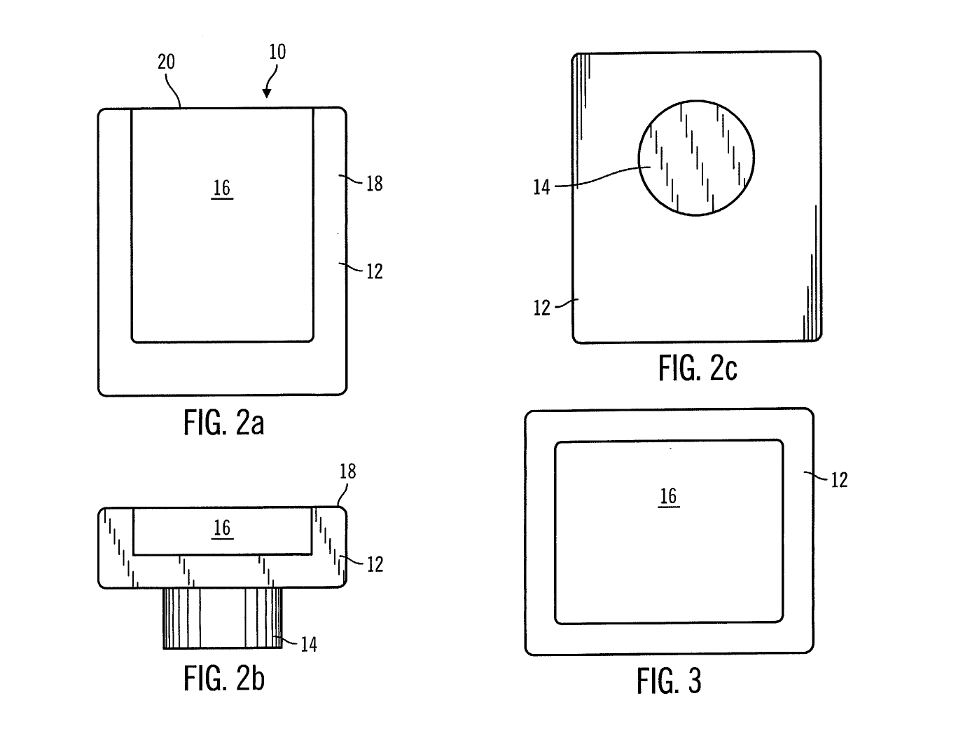

Turning now to the drawings, in FIGS. 1 and 2a-c a first embodiment of a holder 10 according to the invention which is adapted for use with a center console having a cup holder includes a base 12, a projection 14 and a receptacle 16 defined in the upper surface 18 of base 12. Projection 14 is adapted to register within the cup holder of the center console, thereby releasably securing the base 12 to the center console. In specific embodiments, projection 14 is a cylindrical projection, i.e., has a substantially circular cross-section. Other appropriate shapes can be selected through exercise of routine design choice. Projection 14 can be formed, for example, as an open-topped element the upper circumference of which is flush with the bottom surface of the receptacle 16 (i.e., such that the interior of the projection 14 is in communication with the receptacle 16), or can be a open-bottomed, closed-topped element that is separately secured to the base 12 or is formed unitarily with the base 12 (i.e., formed from the same material as, and as a single piece together with, base 12). Other configurations of projection 14 will be readily apparent to those skilled in the art.

In more particular embodiments, projection 14 can be rotationally engaged with base 12, for example by a nut and bolt 15a-b (see FIG. 2b) or other means oriented along an axis of rotation 15--15 of projection 14, in order to allow movement of the base 12 in a plane of rotation. More preferably, the nut or other securing means so employed does not protrude into receptacle 16, in order to avoid contact with the article, in particular a personal CD player, secured within the receptacle.

In additional more particular embodiments, projection 14 can be weighted or ballasted in order to increase the stability of the holder 10 when engaged within the cup holder of the center console. For example, the projection 14 can be a solid projection that is unitary with base 12, a solid projection that is formed separately and then releasably or permanently affixed to the base 12, or a hollow projection that is at least partially filled with a ballast material, such as sand, plastic or metal pellets, etc. and then secured to the base 12.

Receptacle 16 is adapted to receive an article, in particular a personal CD player, thereby securing the article to the base. As shown in FIG. 1, for example, the receptacle can be substantially conformal with the article, in particular a personal CD player, in order to minimize movement of the article within the receptacle. Once secured, a CD player can then be played through the vehicle's audio system via a tape deck adapter (not shown) or other known means.

Holder 10 can be formed from any desired material, such as plastic, metal, wood, etc. In particular embodiments, holder 10 is formed from a polymeric material by a molding process, such as injection molding, vacuum molding or the like. More specifically, holder 10 is formed as a single element without the need for assembly of two or more separate elements.

Receptacle 16 in FIGS. 1 and 2a-c has an open side along top edge 20 of base 12. In an alternative receptacle configuration shown in FIG. 3, receptacle 16 is completely enclosed.

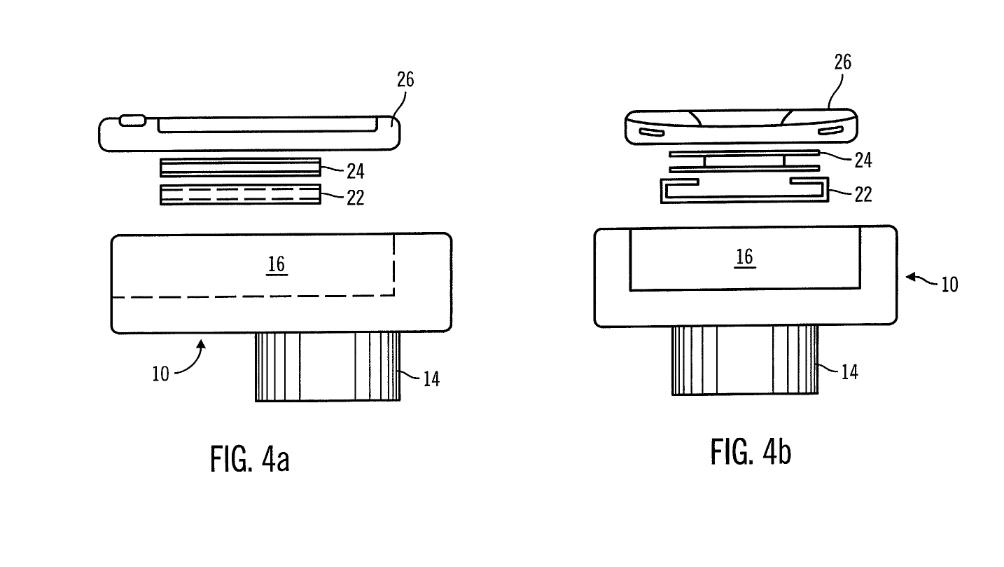

In FIGS. 4a-b, receptacle 16 is provided with a slotted member 22, within which a grooved member 24 slidingly engages. Grooved member 24 in turn is affixed, for example using an adhesive, to personal CD player 26. By slidingly engaging grooved member 24 within slotted member 22, personal CD player 26 is retained more securely within receptacle 16.

The slotted and grooved members of FIGS. 4a-b can be used with other embodiments of the inventive holder as desired.

If desired, the base of the inventive holder can be formed without a receptacle defined in its upper surface. The article to be retained, such as a personal CD player, is secured to the upper surface by any desired means, such as the grooved and slotted members shown in FIGS. 4a-b, by flexible fasteners such as one or more straps, by releasable adhesives applied to the upper surface of the holder and/or the bottom surface of the article to be secured, or by any other means.

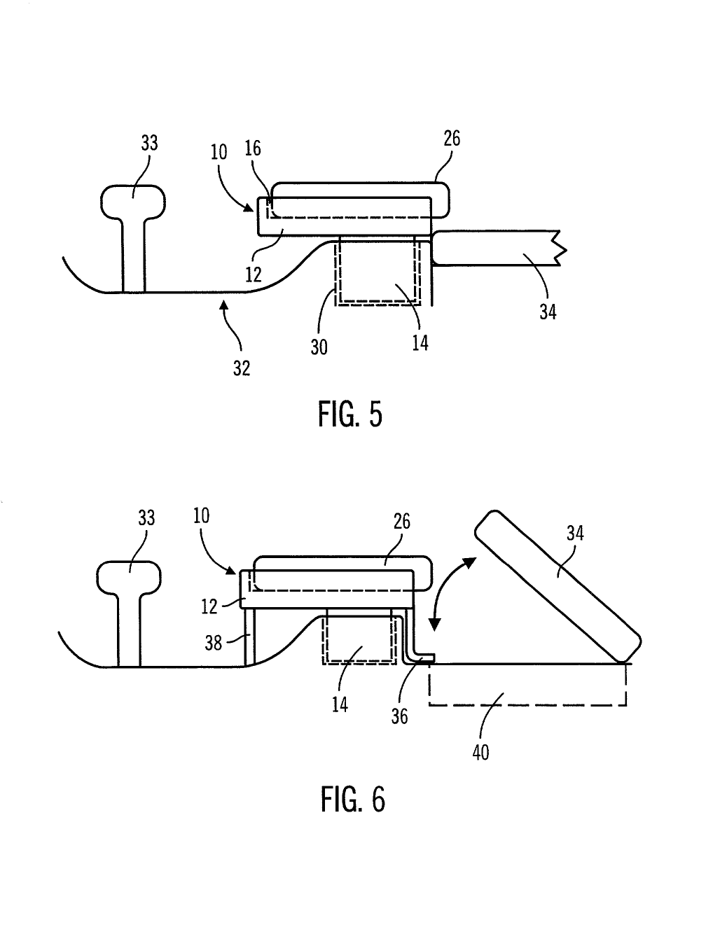

The relationship of the holder 10 of FIGS. 1 and 2a-c to the center console of the vehicle to which it is secured is illustrated in FIG. 5. Projection 14 of holder 10 registers within cup holder 30 of console 32 and extends toward shift 33. Personal CD player 26 is secured within receptacle 16 of holder 10, and is readily accessible to the driver of the vehicle.

As illustrated, the open side of receptacle 16 faces rearward with respect to the interior of the vehicle. The open side can also be oriented to face forward.

For additional stability, an alternative embodiment of holder 10 illustrated in FIG. 6 is provided with a securing flange 36 which extends between and partially under cover 34 of compartment 40 defined within console 30. When cover 34 is closed, the cover holds securing flange 36 in place, thus further securing holder 10 to console 30. Additional stability is also provided by support 38 which extends downward from base 12 to contact console 32.

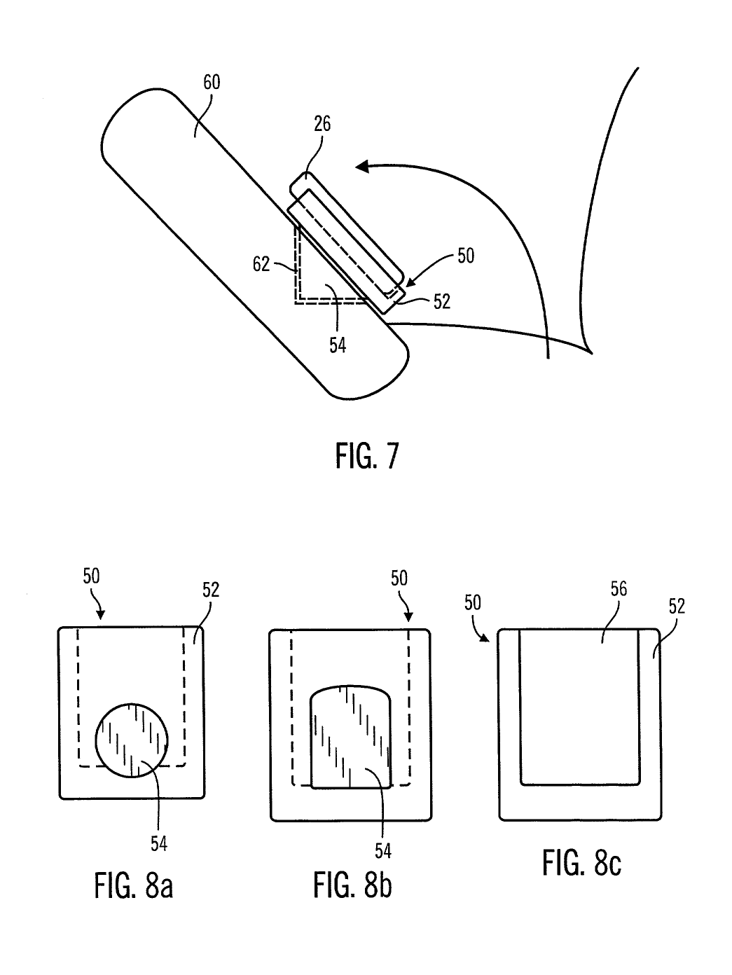

An alternative embodiment of a holder 50 is illustrated in FIGS. 7 and 8a-c. Some vehicles include center consoles 60 which rotate upward to form an inclined structure. Holder 50 includes base 52 and angled projection 54 adapted to register within cup holder 62 defined in the inclined console 60. A personal CD player 26 or other article is secured within receptacle 56 defined in upper surface 58 of base 52 in a manner similar to those described previously.

Other configurations of the inventive holder are that are suitable for use with center consoles having orientations and/or elements (such as covers) other than those illustrated herein will be readily apparent to those skilled in the art. All such configurations are considered to be encompassed by the present invention.

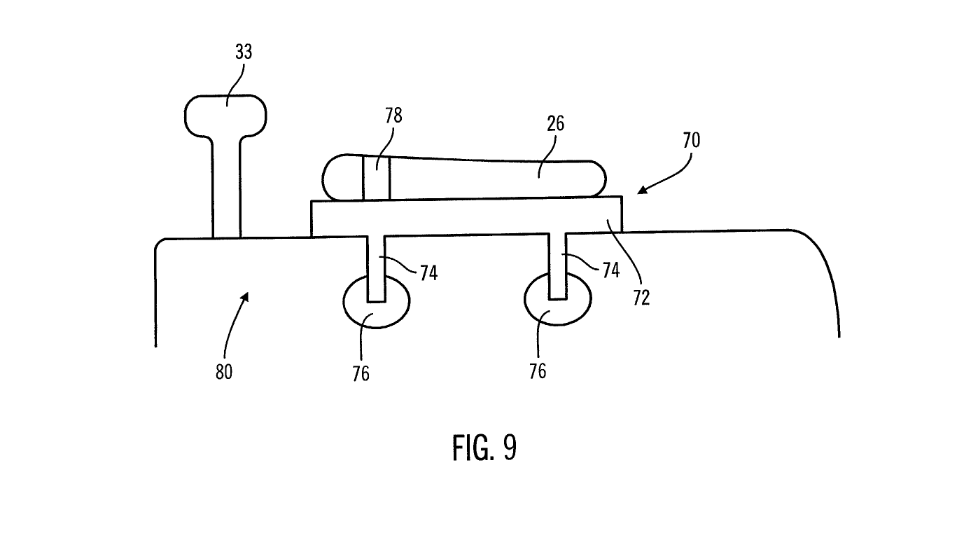

In the foregoing embodiments, the holder is releasably secured to the center console by means of a projection which registers within a cup holder defined in the center console. Other means for securing the holder (releasably or non-releasably) to a center console are also considered to be within the scope of the present invention. For example, as shown in FIG. 9, holder 70 includes a base 72 from which arms 74 downwardly project. Suction cups 76 affixed to arms 74, when pressed against console 80, secure holder 70 to the center console. Personal CD player 26 is then secured to base 72 by any desired means, such as strap 78 as shown in FIG. 9, by means of a receptacle defined in base 72 in the manner described above, or by any other means. Other means for securing the inventive holder to a center console, such as clamps, straps, adhesives, mechanical fasteners such as screws or bolts, etc. can also be used.

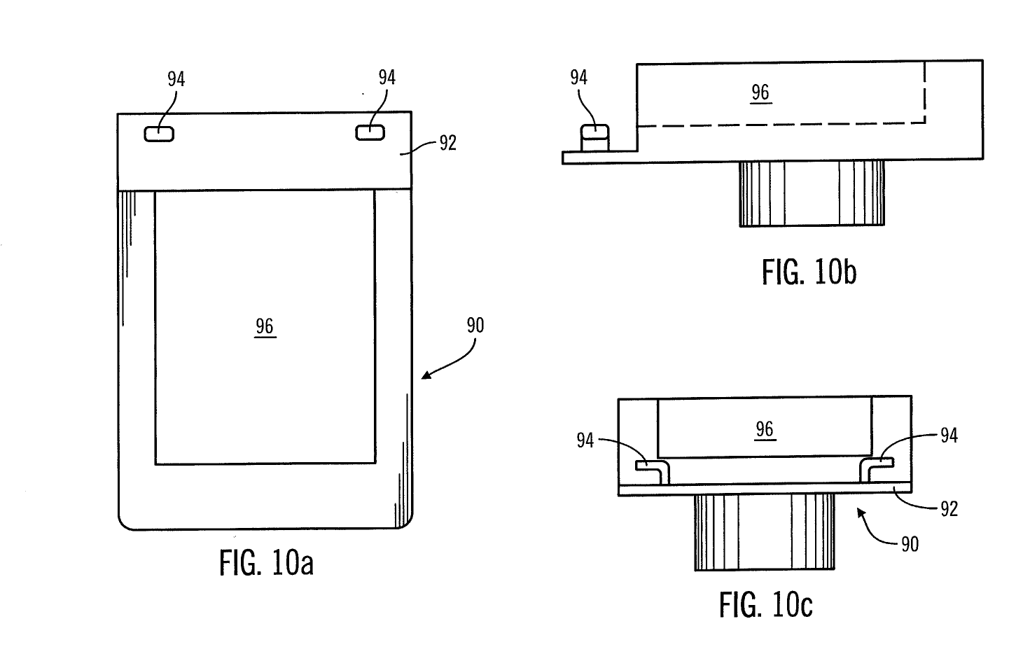

In FIGS. 10a-c, an alternative embodiment of the inventive holder 90 includes a ledge 92 and prongs 94. When an article such as a personal CD player is secured to holder 90 (in the illustration by disposing the article within receptacle 96), and a power cord (not shown) which supplies power to the article is plugged into a cigarette lighter located in the center console, any excess length of the power cord is wrapped around prongs 94 to retain the cord in place. Alternatively, excess lengths of power cord are secured by wrapping around posts or other elements, by grasping elements such as clips, by elastic devices, straps, etc. In a like manner, excess lengths of tape deck adapter cord (also not shown) can be secured.

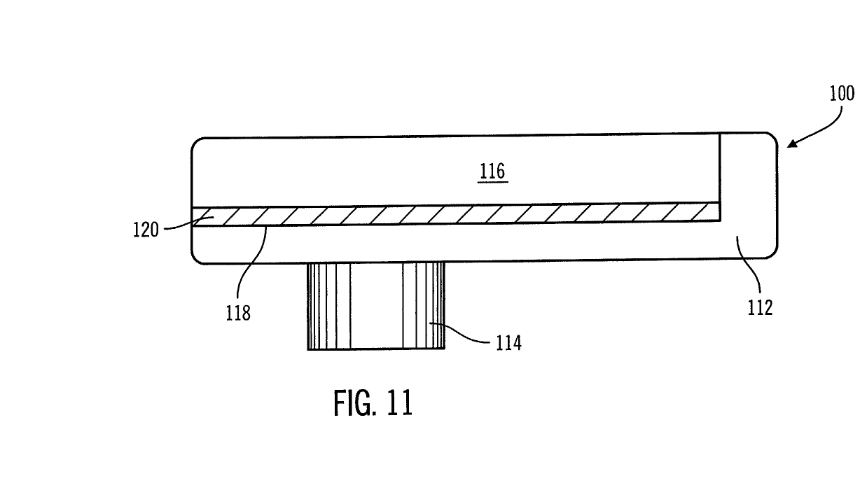

FIG. 11 illustrates an alternative embodiment which is particularly in situations in which excessive vibration may cause a personal CD player to skip. Holder 100 includes base 112 and projection 114, and has defined therein receptacle 116 for receiving the article to be secured, such as a personal CD player. On the lower surface 118 of receptacle 116 is disposed a resilient element 120 which dampens vibrations transmitted from the center console to the article secured to holder 100. Resilient element 120 is comprised, for example, of a layer of a resilient material such as a foamed polymer. Other resilient elements useful in accordance with the invention include packaged liquids, gels or granulated materials, air cushions, small springs, and the like.

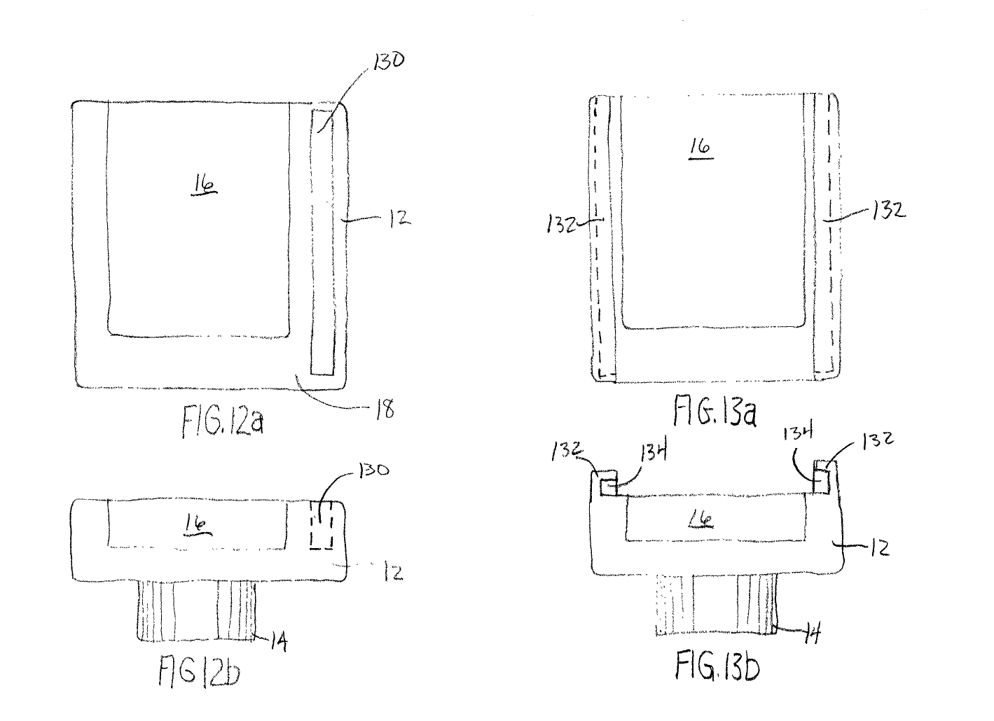

FIGS. 12a-b illustrate an alternative embodiment of the inventive holder that includes means for securing a CD jewel case, as illustrated a jewel case receptacle 130 defined in upper surface 18 of base 12. Jewel case receptacle 130 can be defined in any portion of upper surface 18 that is appropriately dimensioned. The illustrated configuration permits a CD jewel case to be secured in a substantially vertical orientation, which facilitates placement of the jewel case in the receptacle, and removal of the jewel case therefrom, by a vehicle occupant.

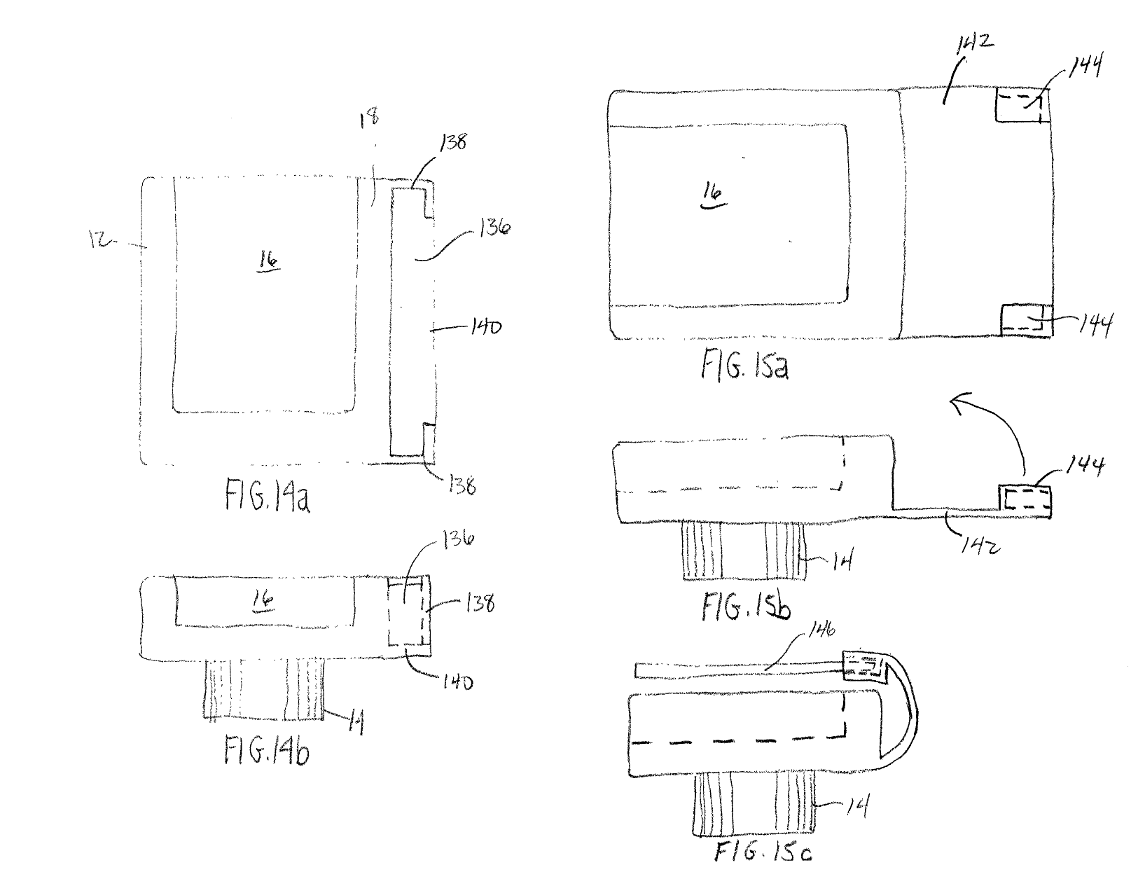

FIGS. 13a-b illustrate another embodiment of the inventive holder in which the means for securing the CD jewel case include parallel upper brackets 132 defining slots 134. The CD jewel case registers within the slots 134. This position is additionally advantageous in providing protection for a CD player secured within receptacle 16 from spilled beverages and other foreign objects, as well as allowing ready viewing of the front or back surface of the jewel case by vehicle occupants.

Another alternative embodiment, illustrated in FIGS. 14-b, includes an external jewel case receptacle 136 defined by side brackets 138 and base extension 140. Again, the jewel case receptacle is appropriately sized to accommodate a CD jewel case in a substantially vertical orientation. Brackets 138 and base extension 140 in more specific embodiments are formed as a single piece with the remainder of base 12 of the holder. If desired, the portion of base extension 140 between the brackets 138 can be omitted, in effect providing separate brackets 138 at each end of the edge of base 12 for securing the jewel case.

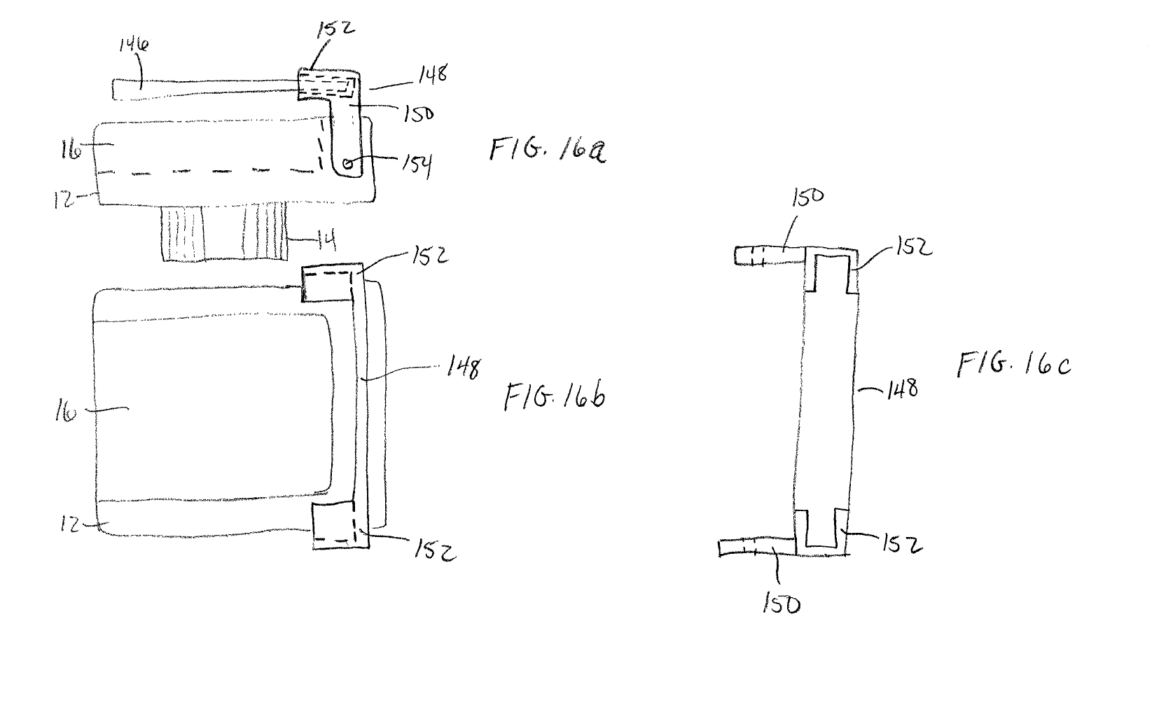

A flexible base extension can also be employed in alternative embodiments of the inventive holder. In FIGS. 15a-c, flexible base extension 142 and brackets 144 are employed to secure a CD jewel case 146. As shown in FIG. 15c, base extension 142 can be flexed such that the jewel case is positioned above receptacle 16, thus providing additional protection for a CD player secured therein and allowing ready viewing of the front or back surface of the jewel case.

In FIGS. 16a-c, jewel case holder 148 includes arms 150 and brackets 152 that engage jewel case 146. Arms 150 pivotally engage base 12 via pivots 154. By pivoting jewel case holder 148, jewel case 148 can be more easily inserted between brackets 152 in an orientation varying from substantially vertical to substantially horizontal, and then if desired rotated toward upper surface 18 of holder 12.

In variations of the preceding embodiments, the various brackets can be replaced with a single continuous structure which surrounds an end of a CD jewel case, thus forming an integral receptacle for the end of the jewel case.

In various specific embodiments of the present invention, including without limitation those illustrated in FIGS. 13a-b, 15a-c and 16a-c above, the means for securing the CD jewel case are configured such that the CD jewel case so secured, together with the base of the holder, at least partially sandwiches a personal CD player secured to the base. Other at least partially sandwiching configurations will be readily apparent to those skilled in the art.

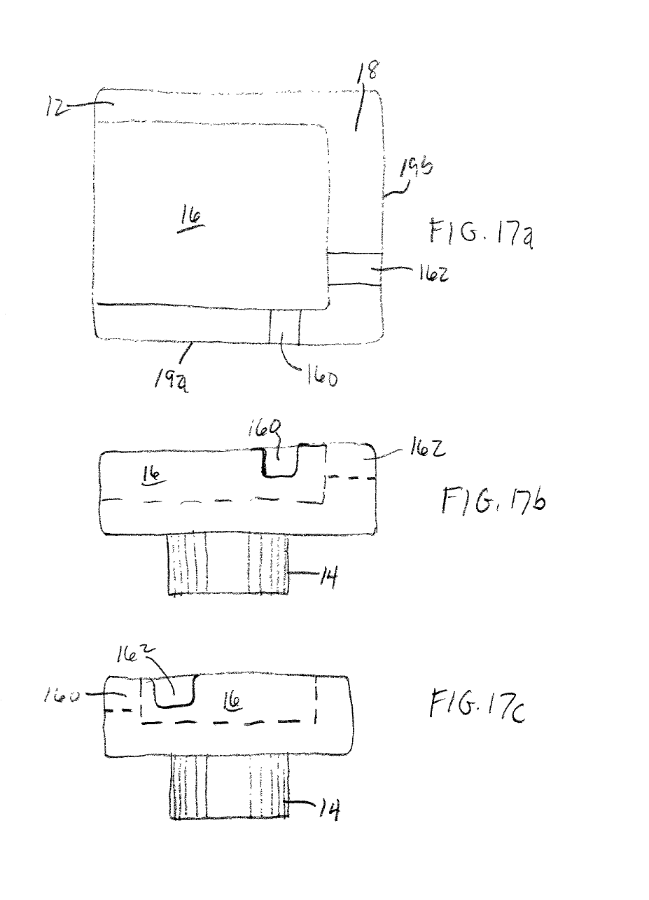

A further embodiment of the inventive holder illustrated in FIGS. 17a-c includes a power plug receptacle 160 and an audio plug receptacle 162. In the illustrated embodiment, the receptacles 160 and 162 are defined as recesses extending downward from upper surface 18 and inward from side surface 19a and rear surface 19b, respectively, of base 12. Power plug 164 and audio plug 166, respectively, are received within the corresponding receptacles. The plugs 162 and 164 are positioned within the respective receptacles when they are inserted in the corresponding power socket 168 and audio socket 170 of CD player 26. Other receptacles can also be defined if desired, for example, recesses defined solely in surfaces 19a and 19band extend inward to allow plugs 164 and 166 to engage power socket 168 and audio socket 170. Depending on the configuration of the CD player held within receptacle 16, the receptacles 160 and 162 will be disposed at various locations on holder 10.

Use of two receptacles 160 and 162 is illustrated, but either of the illustrated receptacles can be used separately depending on the configuration of the CD player which is to be held by holder 10.

Alternatively, holder 10 can be provided with separate jack extensions which extend through holder 10 to engage the CD player's power socket and/or audio socket. A power plug and/or audio plug then can be inserted within the appropriate jack extension externally of holder 10.

Although the inventive holders have been illustrated primarily in relation to vehicle center consoles, they can also be adapted to be secured to other elements within a vehicle, such as the front dashboard, a ceiling projection or compartment, etc. Holders so adapted are considered to constitute part of the invention.

What is claimed is:

1. A holder for releasably securing a personal CD player within a motor vehicle, said holder comprising:
(a) a base, (b) means for securing said base within said motor vehicle, (c) means for securing said CD player to said base, and (d) means for securing a CD jewel case.

2. The holder of claim 1 wherein said motor vehicle is equipped with a center console having a cup holder, and wherein said means (b) comprise a projection which registers within said cup holder.

3. The holder of claim 2 wherein said projection is ballasted.

4. The holder of claim 1 wherein said base (a) has an upper surface, and wherein said means (c) comprise a receptacle defined in said upper surface within which said personal CD player registers.

5. The holder of claim 4 wherein said upper surface of said base (a) has defined therein at least one selected from the group consisting of a power plug receptacle and an audio jack receptacle.

6. The holder of claim 1 wherein said means (d) comprise a receptacle defined in said base (a) which is adapted to engage at least a portion of a CD jewel case.

7. The holder of claim 1 wherein said means (d) comprise a base extension and a means affixed thereto which are adapted to engage at least a portion of a CD jewel case.

8. The holder of claim 7 wherein said means affixed to said base extension comprise a pair of brackets.

9. The holder of claim 7 wherein said base extension is flexible and wherein said means (d) are positionable such that a CD jewel case secured therein extends at least partially over a personal CD player secured by said means (c).

10. The holder of claim 1 wherein said base (a) has an upper surface, and wherein said means (d) comprise parallel brackets adapted to receive a CD jewel case such that said CD jewel case received therein extends over at least a portion of said means (c).

11. The holder of claim 1 wherein said means (d) comprise (i) a receptacle for engaging at least a portion of a CD jewel case and (ii) a pair of arms pivotally securable to said base (a).

12. The holder of claim 1 wherein said means for securing a CD jewel case are adapted to position said CD jewel case such that a personal CD player secured to said base is at least partially sandwiched between said base and said CD jewel case.

13. A method for releasably securing a personal CD player and CD jewel case within a motor vehicle, said method comprising the steps of
(i) securing the holder of claim 1 within said motor vehicle,
(ii) securing said personal CD player to said base (a) of said holder, and
(iii) securing said CD jewel case to said holder using means (d).
